(19) United States
(12) Patent Application Publication
(10) Pub. No.: US 2020/0115595 A1
(43) Pub. Date: Apr. 16, 2020

(54) PRIMER COMPOSITION FOR PRESSURE-SENSITIVE SILICONE ADHESIVE, AND ARTICLE

(71) Applicant: SHIN-ETSU CHEMICAL CO., LTD., Tokyo (JP)

(72) Inventors: Osamu TSUCHIDA, Tokyo (JP); Shunji AOKI, Annaka-shi (JP)

(73) Assignee: SHIN-ETSU CHEMICAL CO., LTD., Tokyo (JP)

(21) Appl. No.: 16/500,012

(22) PCT Filed: Mar. 9, 2018
(86) PCT No.: PCT/JP2018/009201

§ 371 Date: Oct. 1, 2019

(30) Foreign Application Priority Data
Apr. 12, 2017 (JP) 2017-078982

(51) Int. Cl. C09J 7/50; C09J 7/38; C09J 183/04

(52) U.S. Cl. CPC C09J 7/50; C09J 7/38; C08G 77/20; C09J 2483/003; C09J 183/04

(57) ABSTRACT

A primer composition for pressure-sensitive silicone adhesives which comprises (A) an organopolysiloxane including at least two alkenyl-containing organic groups in the molecule and having an alkenyl group content of 0.001-0.008 mol per 100 g of the organopolysiloxane, (B) an organopolysiloxane including at least two alkenyl-containing organic groups in the molecule and having an alkenyl group content of 0.15-1.3 mol per 100 g of the organopolysiloxane, (C) an organohydrogenpolysiloxane having at least three Si—H groups in the molecule but containing neither any alkoxy group nor any epoxy group, and (D) a platinum-group metal catalyst. The primer composition cures satisfactorily while sufficiently exhibiting adhesiveness to pressure-sensitive silicone adhesives. Even after having cured sufficiently, the primer composition can retain the satisfactory adhesiveness.

### TECHNICAL FIELD

This invention relates to a primer composition for silicone pressure-sensitive adhesives, and an article having a cured coating of the composition on the surface of a substrate.

### BACKGROUND ART

Pressure-sensitive adhesive (PSA) labels and tapes which are manufactured by coating a PSA on a substrate or backing are used in a variety of industrial fields. Paper and plastic film are used as the substrate. Paper base PSA labels are indispensable for the identification of items in the shop and found in every aspect of daily life.

On the other hand, plastic film base PSA tapes or labels include tapes of universal use such as cellophane tape and high-performance tapes used in severer environments such as heat resistant tapes based on high-temperature film.

The materials of PSAs include rubber, acrylic and silicone materials. Of these, silicone materials are believed to be most durable. Specifically, because of satisfactory heat resistance, freeze resistance, weathering resistance, chemical resistance, and electrical insulation, silicone PSAs are used where such properties are necessary. Although silicone PSAs are expensive as compared with other organic PSAs, the silicone PSAs are used as the material for industrial high-performance PSA products to which the other organic PSAs are not successfully applicable.

Also, silicone PSAs have the advantage that surface wetting is quite excellent because of the structure of the base material so that few bubbles are entrained upon sticking of tape. To make good use of this advantage, silicone PSAs are recently used as the PSA in PSA film for protecting displays on mobile phones and the like. Since smart phones and tablets of the touch panel structure are susceptible to staining as a result of the finger touching the screen directly, it is a common practice to lay an anti-staining coated film on the screen. The consumption amount of such film is increasing.

For these reasons, silicone PSAs often use substrates of plastic film. However, it is pointed out that plastic film substrates are less adherent to resins to be coated thereon as compared with paper substrates. The lack of adhesion may raise problems, for example, back transfer upon winding in roll form. Also, when the PSA film is peeled from the adherend after a lapse of time from the attachment of PSA to the adherend, the PSA layer is left on the adherend.

From the past, several measures were taken to improve adhesion, for example, use of more adhesive substrates and corona treatment of substrates. Also primer treatment is on widespread use. Efforts are made to develop primer compositions for silicone PSAs.

Patent Document 1 (JP-B H06-39584) describes that a coating obtained by curing a composition based on a silanol-endcapped organopolysiloxane in the presence of a metal catalyst is used as a primer, and a PSA layer is formed thereon, whereby good adhesion to a substrate is achieved. Although a tin catalyst is effective for curing the primer composition, it adds an environmental burden, raising another problem. Thus a primer composition of hydrosilylation addition cure type using a platinum group catalyst is newly studied.

Patent Documents 2 to 5 (JP-A 2002-338890, 2010-184953, 2012-149240, and 2013-139509) describe a composition comprising an organopolysiloxane having an alkenyl-containing organic group as a base, an organopolysiloxane having a Si—H group and a metal catalyst. A coating obtained from hydrosilylation addition cure of the composition is used as a primer for PSAs. In these patent documents, however, the cure behavior of the primer composition is discussed nowhere, and the adhesion of PSA after primer coating is solely discussed throughout the disclosure. In practice, the range of primer composition within which the primer composition is fully curable is limited, and few patent documents find a composition meeting both cure and adhesion.

Also, it is empirically known that once a primer is completely cured, a PSA is less adhesive thereto. The technique of maintaining satisfactory adhesion using a fully cured primer has not been established. If such technique is established, the versatility of primer is expandable.

### PRIOR ART DOCUMENTS

### Patent Documents

Patent Document 1: JP-B H06-39584

Patent Document 2: JP-A 2002-338890

Patent Document 3: JP-A 2010-184953

Patent Document 4: JP-A 2012-149240

Patent Document 5: JP-A 2013-139509

### SUMMARY OF INVENTION

### Technical Problem

An object of the invention, which has been made under the above-mentioned circumstances, is to provide a primer composition for silicone PSA, which exhibits satisfactory adhesion to the silicone PSA, which itself is fully curable, and which maintains satisfactory adhesion even after it is fully cured; and an article having a cured coating of the primer composition on the surface of a substrate.

### Solution to Problem

Making extensive investigations to attain the above object, the inventors have found that the sole use of a single alkenyl-containing siloxane is a problem common to the above-cited patent documents 2 to 5, that a composition capable of meeting both the cure behavior of a primer composition and the adhesion of a cured coating of the primer composition and a silicone PSA is established by using at least two organopolysiloxanes having substantially different alkenyl contents as the base, and that when a silane coupling agent is used in combination, satisfactory adhesion is maintained even after full curing. The invention is predicated on this finding.

Accordingly, the invention provides a primer composition for silicone PSAs and an article having a cured coating of the primer composition, as defined below.

A primer composition for silicone pressure-sensitive adhesives, comprising:
(A) 100 parts by weight of an organopolysiloxane containing at least two alkenyl-containing organic groups in the molecule and having an alkenyl content of 0.001 to 0.008 mole per 100 g of the organopolysiloxane, represented by the average compositional formula (1):

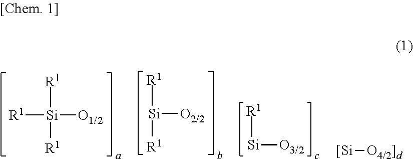

wherein R¹ which may be the same or different is a hydroxyl group, C₁-C₃ alkoxy group, substituted or unsubstituted C₁-C₁₀ monovalent hydrocarbon group free of aliphatic unsaturation, or C₂-C₁₀ alkenyl-containing organic group, at least two of R¹ being C₂-C₁₀ alkenyl-containing organic groups, a is an integer of at least 2, b is an integer of at least 1, c and d each are an integer of at least 0, and 400≤a+b+c+d≤2,000,
(B) 1 to 20 parts by weight of an organopolysiloxane containing at least two alkenyl-containing organic groups in the molecule and having an alkenyl content of 0.15 to 1.3 moles per 100 g of the organopolysiloxane, represented by the average compositional formula (2):

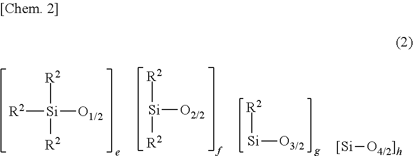

wherein R² which may be the same or different is a hydroxyl group, C₁-C₃ alkoxy group, substituted or unsubstituted C₁-C₁₀ monovalent hydrocarbon group free of aliphatic unsaturation, or C₂-C₁₀ alkenyl-containing organic group, at least two of R² being C₂-C₁₀ alkenyl-containing organic groups, e to h each are an integer of at least 0, and 2≤e+f+g+h≤20,
(C) an organohydrogenpolysiloxane containing at least three Si—H groups in the molecule, but not alkoxy and epoxy groups, in such an amount that a molar ratio of Si—H groups to the total of alkenyl groups in components (A) and (B) ranges from 0.5/1 to 30/1, and
(D) a platinum group metal based catalyst for promoting hydrosilylation addition reaction between alkenyl groups in components (A) and (B) and Si—H groups in component (C) for curing, in such an amount as to give 1 to 500 ppm of metal based on the weight of component (A).

The primer composition of [1], further comprising (E) 0.01 to 5 parts by weight of a reaction regulator per 100 parts by weight of components (A) to (C) combined.

The primer composition of [1] or [2], further comprising (F) 0.5 to 10 parts by weight of a silane coupling agent per 100 parts by weight of component (A).

The primer composition of [3] wherein component (F) is a silane coupling agent having the general formula (3):

Rᵢ³Si(OR⁴)₄₋ᵢ (3)

wherein R³ is a monovalent organic group free of nitrogen, sulfur, phosphor and tin elements, R⁴ is C₁-C₄ alkyl, and i is a number 1≤i≤3.

The primer composition of any one of [1] to [4], further comprising (G) 0.1 to 10 parts by weight of a compound having the general formula (4) or (5) per 100 parts by weight of component (A),

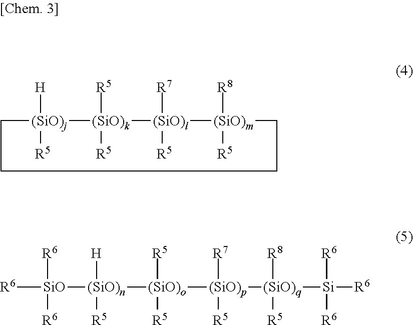

wherein R⁵ which may be the same or different is a substituted or unsubstituted C₁-C₁₀ monovalent hydrocarbon group free of aliphatic unsaturation, R⁶ is hydrogen or R⁵, R⁷ is an epoxy-containing organic group, R⁸ is an alkoxysilyl-containing organic group, j and n each are an integer of at least l, k and o each are an integer of at least 0, l, m, p and q each are an integer of at least 0, l+m and p+q each are an integer of at least 1.

The primer composition of any one of [1] to [5], further comprising (H) 5 to 2,000 parts by weight of an organic solvent per 100 parts by weight of component (A).

An article comprising a substrate and a cured coating of the primer composition of any one of [1] to [6] thereon.

A pressure-sensitive adhesive article comprising the article of [7] and a cured product of a silicone pressure-sensitive adhesive composition on the surface of the cured coating of the primer composition.

The pressure-sensitive adhesive article of [8] wherein the silicone pressure-sensitive adhesive composition is curable through hydrosilylation.

### Advantageous Effects of Invention

By coating the inventive primer composition for silicone PSA onto a substrate, curing the primer, coating a silicone PSA composition thereon and curing the PSA composition, there is provided a PSA article using the silicone PSA having satisfactory adhesion to the substrate. Since the inventive primer composition for silicone PSA is effectively curable, the off-line procedure of once winding up the primer-coated substrate is possible, rather than the in-line procedure of successively coating the primer and the silicone PSA.

### DESCRIPTION OF EMBODIMENTS

Now the invention is described in detail.

One embodiment of the invention is a primer composition for silicone PSAs, comprising:
(A) an organopolysiloxane containing at least two alkenyl-containing organic groups in the molecule and having an alkenyl content of 0.001 to 0.008 mole per 100 g of the organopolysiloxane, represented by the formula (1) below,
(B) an organopolysiloxane containing at least two alkenyl-containing organic groups in the molecule and having an alkenyl content of 0.15 to 1.3 moles per 100 g of the organopolysiloxane, represented by the formula (2) below,
(C) an organohydrogenpolysiloxane containing at least three Si—H groups in the molecule, but not alkoxy and epoxy groups,
(D) a platinum group metal based catalyst, and optionally,
(E) a reaction regulator,
(F) a silane coupling agent,
(G) a compound having the formula (4) or (5) below, and
(H) an organic solvent.

### [Component (A)]

Component (A) is an organopolysiloxane containing at least two alkenyl-containing organic groups in the molecule, represented by the average compositional formula (1).

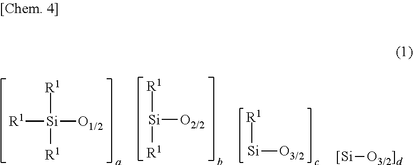

Herein R¹ which may be the same or different is a hydroxyl group, C₁-C₃ alkoxy group, substituted or unsubstituted C₁-C₁₀ monovalent hydrocarbon group free of aliphatic unsaturation, or C₂-C₁₀ alkenyl-containing organic group, at least two of R² being C₂-C₁₀ alkenyl-containing organic groups, a is an integer of at least 2, b is an integer of at least 1, c and d each are an integer of at least 0, and 400 a+b+c+d 2,000.

In formula (1), R¹ is a hydroxyl group, a C₁-C₃ alkoxy group such as methoxy, ethoxy or propoxy, a substituted or unsubstituted C₁-C_{10,} especially C₁-C₈ monovalent hydrocarbon group free of aliphatic unsaturation, or C₂-C_{10,} especially C₂-C₈ alkenyl-containing organic group. At least two of groups R¹ in the molecule are C₂-C₁₀ alkenyl-containing organic groups.

Suitable substituted or unsubstituted monovalent hydrocarbon groups free of aliphatic unsaturation, represented by R¹, include alkyl groups such as methyl, ethyl, propyl and butyl, cycloalkyl groups such as cyclohexyl, aryl groups such as phenyl, and substituted forms of the foregoing in which some or all carbon-bonded hydrogen atoms are substituted by halogen atoms, such as trifluoromethyl and 3,3,3-trifluoropropyl. Inter alia, methyl and phenyl are preferred.

Suitable alkenyl-containing organic groups, represented by R¹, include alkenyl groups such as vinyl, allyl, hexenyl and octenyl, acryloylalkyl and methacryloylalkyl groups such as acryloylpropyl, acryloylmethyl, and methacryloylpropyl, cycloalkenylalkyl groups such as cyclohexenylethyl, and alkenyloxyalkyl groups such as vinyloxypropyl. Inter alia, vinyl is preferred.

In formula (1), a is an integer of at least 2, preferably 2 to 6, b is an integer of at least 1, preferably 384 to 1,998, c and d each are an integer of at least 0, preferably 0 to 5, and 400 a+b+c+d 2,000, preferably 450 a+b+c+d 1,900, more preferably 500 <a+b+c+d 1,800. When a+b+c+d is at least 400, sufficient substrate adhesion (i.e., adhesion to a substrate) is available. If a+b+c+d is more than 2,000, cure is insufficient.

The content of alkenyl in component (A) is 0.001 to 0.008 mole, preferably 0.0015 to 0.0075 mole, more preferably 0.002 to 0.007 mole per 100 g of the organopolysiloxane. If the alkenyl content is less than 0.001 mole, cure is insufficient.

When the alkenyl content is up to 0.008 mole, sufficient substrate adhesion is available.

As used herein, the alkenyl content may be measured by adding 10 wt % potassium iodide aqueous solution to a sample, stirring to form a test solution, and adding dropwise 0.1N sodium thiosulfate to the test solution until the test solution turns colorless (the same holds true, hereinafter).

Examples of component (A) include those of the following general formulae, but are not limited thereto.

R¹⁻¹R¹⁻²₂SiO(R¹⁻²₂SiO)_{A}SiR¹⁻²₂R¹⁻¹ (i)

R¹⁻¹R¹⁻²₂SiO(R¹⁻²₂SiO)_{A}(R¹⁻¹R¹⁻²SiO)_{B}SiR¹⁻²₂R¹⁻¹ (ii)

R¹⁻¹₃SiO(R¹⁻²₂SiO)_{A}(R¹⁻¹R¹⁻²SiO)_{B}SiR¹⁻¹₃ (iii)

R¹⁻²₃SiO(R¹⁻²₂SiO)_{A}(R¹⁻¹R¹⁻²SiO)_{B}SiR¹⁻²₃ (iv)

Herein R¹⁻¹ which may be the same or different is a C₂-C₁₀ alkenyl-containing organic group, and R¹⁻² which may be the same or different is a substituted or unsubstituted C₁-C₁₀ monovalent hydrocarbon group free of aliphatic unsaturation. In formula (i), A≥398; in formulae (ii), (iii) and (iv), A+B≥398 and B≥1, with the proviso that B≥2 where no R¹⁻¹ is contained in the molecule, but (R¹⁻¹R¹⁻²SiO)_{B}.

R¹⁻¹ and R¹⁻² are as exemplified above for R¹. In formula (i), A is preferably in the range: 398≤A≤1,988, especially 448≤A≤1,898. In formulae (ii), (iii) and (iv), A and B are preferably in the range: 398≤A+B≤1,998, especially 448≤A+B≤1,898 and 1≤B≤200, especially 2≤B≤100.

More illustrative examples of component (A) include those of the following general formulae, but are not limited thereto. Notably, Me stands for methyl, Vi for vinyl, and Ph for phenyl.

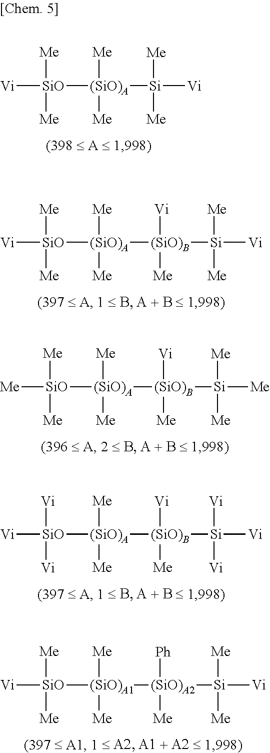

Component (A) is generally prepared by ring-opening polymerization of a cyclic low-molecular-weight siloxane such as octamethylcyclotetrasiloxane with a cyclic low-molecular-weight siloxane having an alkenyl-containing organic group in the presence of a catalyst. Since the reaction product after polymerization contains the reactants, cyclic low-molecular-weight siloxanes, the reaction product is preferably used after the reactants are distilled off at elevated temperature and reduced pressure while passing an inert gas through the reaction product.

### [Component (B)]

Component (B) is an organopolysiloxane containing at least two alkenyl-containing organic groups in the molecule, represented by the average compositional formula (2).

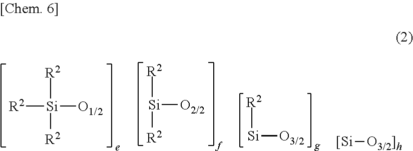

Herein R² which may be the same or different is a hydroxyl group, C₁-C₃ alkoxy group, substituted or unsubstituted C₁-C₁₀ monovalent hydrocarbon group free of aliphatic unsaturation, or C₂-C₁₀ alkenyl-containing organic group, at least two of R² being C₂-C₁₀ alkenyl-containing organic groups, e to h each are an integer of at least 0, and 2≤e+f+g+h≤20.

In formula (2), R² is a hydroxyl group, a C₁-C₃ alkoxy group such as methoxy, ethoxy or propoxy, a substituted or unsubstituted C₁-C_{10,} especially C₁-C₈ monovalent hydrocarbon group free of aliphatic unsaturation, or a C₂-C_{10,} especially C₂-C₈ alkenyl-containing organic group. At least two of groups R² are C₂-C₁₀ alkenyl-containing organic groups.

Suitable substituted or unsubstituted monovalent hydrocarbon groups free of aliphatic unsaturation, represented by R², include alkyl groups such as methyl, ethyl, propyl and butyl, cycloalkyl groups such as cyclohexyl, aryl groups such as phenyl, and substituted forms of the foregoing in which some or all carbon-bonded hydrogen atoms are substituted by halogen atoms, such as trifluoromethyl and 3,3,3-trifluoropropyl. Inter alia, methyl and phenyl are preferred.

Suitable alkenyl-containing organic groups, represented by R², include alkenyl groups such as vinyl, allyl, hexenyl and octenyl, acryloylalkyl and methacryloylalkyl groups such as acryloylpropyl, acryloylmethyl, and methacryloylpropyl, cycloalkenylalkyl groups such as cyclohexenylethyl, and alkenyloxyalkyl groups such as vinyloxypropyl. Inter alia, vinyl is preferred.

In formula (2), e to h each are an integer of at least 0; preferably e is an integer of 2 to 4, f is an integer of 0 to 18, especially 1 to 16, g is an integer of 0 to 2, h is an integer of 0 to 2; and 2≤e+f+g+h≤20, preferably 2≤e+f+g+h≤18. If e+f+g+h is less than 2, no sufficient substrate adhesion is available. When e+f+g+h is up to 20, cure is sufficient.

The content of alkenyl in component (B) is 0.15 to 1.3 moles, preferably 0.18 to 1.25 moles, more preferably 0.20 to 1.2 moles per 100 g of the organopolysiloxane. When the alkenyl content is at least 0.15 mole, cure is sufficient. If the alkenyl content is more than 1.3 moles, no sufficient substrate adhesion is available.

Examples of component (B) include those of the following general formulae, but are not limited thereto.

R²⁻¹R²⁻²₂SiO(R²⁻²₂SiO)_{C}SiR²⁻²₂R²⁻¹

R²⁻¹R²⁻²₂SiO(R²⁻²₂SiO)_{C}(R²⁻¹R²⁻²SiO)_{D}SiR²⁻²₂R²⁻¹

R²⁻¹₃SiO(R²⁻²₂SiO)_{C}(R²¹R²⁻²SiO)_{D}SiR²⁻¹₃

R²⁻²₃SiO(R²⁻²₂SiO)_{C}(R²⁻¹R²⁻²SiO)_{D}SiR²⁻²₃

(R²⁻²₂SiO)_{C}(R²⁻¹R²⁻²SiO)_{D}

Herein R²⁻¹ which may be the same or different is a C₂-C₁₀ alkenyl-containing organic group, R²⁻² which may be the same or different is a substituted or unsubstituted C₁-C₁₀ monovalent hydrocarbon group free of aliphatic unsaturation, C≥0, D≥0, and the sum of C and D is up to 18, with the proviso that D≥2 where no R²⁻¹ is contained in the molecule, but (R²⁻¹R²⁻²SiO)_{D}.

R²⁻¹ and R²⁻² are as exemplified above for R². Notably, C and D are preferably in the range: 0≤C≤18, 0≤D≤18, and 0≤C+D≤18, especially 0≤C+D≤16.

More illustrative examples of component (B) include those of the following general formulae, but are not limited thereto. Notably, Me stands for methyl, Vi for vinyl, and Ph for phenyl.

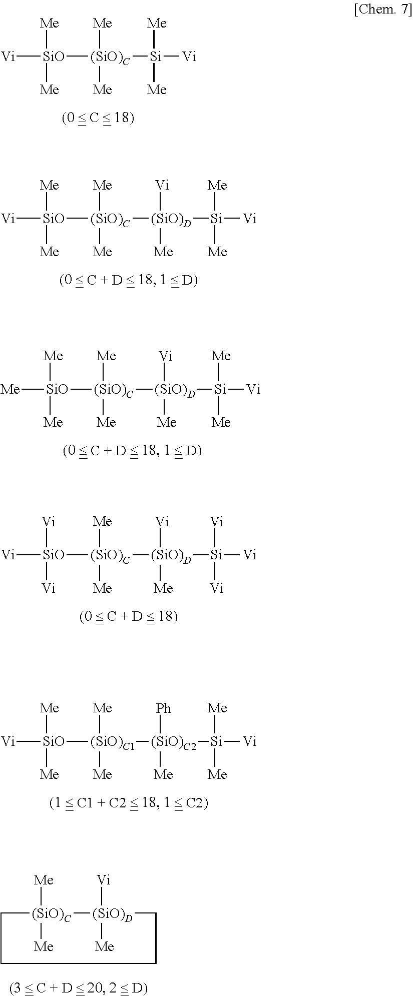

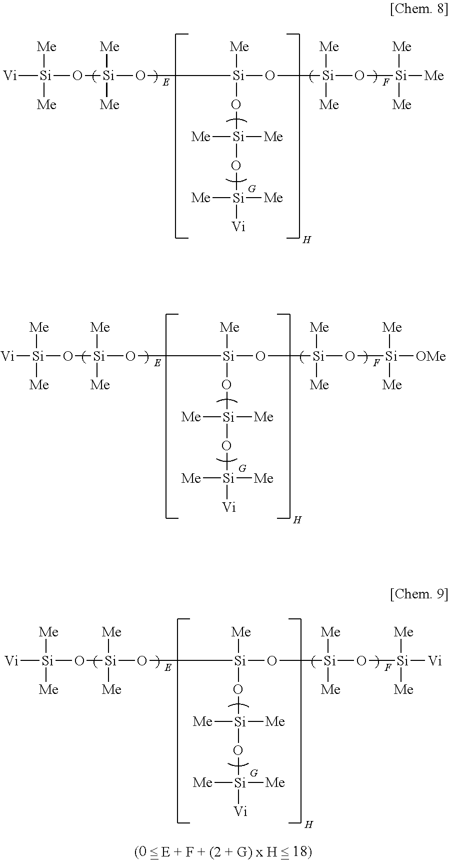

Component (B) is generally prepared by ring-opening polymerization of a cyclic low-molecular-weight siloxane such as octamethylcyclotetrasiloxane with a cyclic low-molecular-weight siloxane having an alkenyl-containing organic group in the presence of a catalyst. Since the reaction product after polymerization contains the reactants, cyclic low-molecular-weight siloxanes, the reaction product is preferably used after the reactants are distilled off at elevated temperature and reduced pressure while passing an inert gas through the reaction product.

Component (B) is blended in an amount of 1 to 20 parts by weight, preferably 1 to 18 parts by weight, more preferably 1 to 15 parts by weight per 100 parts by weight of component (A). a primer composition containing less than 1 part by weight of component (B) is less curable whereas a primer composition containing more than 20 parts by weight of component (B) is poor in substrate adhesion.

### [Component (C)]

Component (C) is an organohydrogenpolysiloxane containing at least three, preferably 5 to 100, more preferably 10 to 80 Si—H groups in the molecule, but not alkoxy and epoxy groups. One illustrative structure has the average compositional formula (6):

R⁹ᵣHₛSiO_{(4-r-s)/2} (6)

wherein R⁹ is independently an unsubstituted or halo-substituted C₁-C₁₀ monovalent hydrocarbon group, r and s are in the range: r>0, s>0, and 0<r+s<3.

In formula (6), R⁹ is a C₁-C₁₀, especially C₁-C₈ monovalent hydrocarbon group, which is preferably free of aliphatic unsaturation. Examples include alkyl groups such as methyl, ethyl, propyl and butyl, cycloalkyl groups such as cyclohexyl, alkenyl groups such as vinyl, allyl, hexenyl, octenyl, aryl groups such as phenyl, and substituted forms of the foregoing in which some or all carbon-bonded hydrogen atoms are substituted by halogen atoms, such as trifluoromethyl and 3,3,3-trifluoropropyl. Inter alia, aliphatic saturated hydrocarbon groups and aromatic hydrocarbon groups are preferred, with methyl and phenyl being more preferred.

The subscripts r and s are numbers in the range: r>0, preferably 1≤r≤3, s>0, preferably 1≤s≤3, and 0<r+s≤3, preferably 2≤r+s≤3.

The molecular structure of the organohydrogenpolysiloxane may be linear, cyclic, branched or three-dimensional network. An organohydrogenpolysiloxane in which the number of silicon atoms per molecule (or degree of polymerization) is about 2 to about 300, especially about 4 to about 150 and which is liquid at room temperature (25° C.) is preferably used.

Examples of component (C) include those having the general formula (7), but are not limited thereto.

R¹⁰₃SiO(R¹¹₂SiO)_{I}(R¹²HSiO)_{J}SiR¹³₃ (7)

Herein R¹⁰ and R¹³ are each independently hydrogen or a C₁-C₁₀, especially C₁-C₈ monovalent hydrocarbon group, R¹¹ and R¹² are each independently a C₁-C₁₀, especially C₁-C₈ monovalent hydrocarbon group, I is 0≤I≤100 and J is 3≤J≤80.

In formula (7), R¹¹ and R¹² each are a C₁-C₁₀ monovalent hydrocarbon group, which is preferably free of aliphatic unsaturation. Examples include alkyl groups such as methyl, ethyl, propyl and butyl, cycloalkyl groups such as cyclohexyl, alkenyl groups such as vinyl, allyl, hexenyl, octenyl, aryl groups such as phenyl, and substituted forms of the foregoing in which some or all carbon-bonded hydrogen atoms are substituted by halogen atoms, such as trifluoromethyl and 3,3,3-trifluoropropyl. R¹¹ and R¹² are preferably aliphatic saturated hydrocarbon groups or aromatic hydrocarbon groups, with methyl and phenyl being more preferred.

R¹⁰ and R¹³ each are hydrogen or a C₁-C₁₀ monovalent hydrocarbon group. Examples of the monovalent hydrocarbon group represented by R¹⁰ and R¹³ are as exemplified above for R¹¹ and R¹². R¹⁰ and R¹³ are preferably hydrogen, an aliphatic saturated hydrocarbon group or aromatic monovalent hydrocarbon group, with hydrogen, methyl and phenyl being more preferred.

The subscripts I and J are in the range: 0≤I≤100, preferably 0≤I≤80, more preferably 0<I≤80, 3≤J≤80, preferably 5≤J≤70, and preferably 10≤I+J≤150, more preferably 20≤I+J≤120.

More illustrative structures of component (C) include those of the following formulae, but are not limited thereto. Notably, Me stands for methyl.

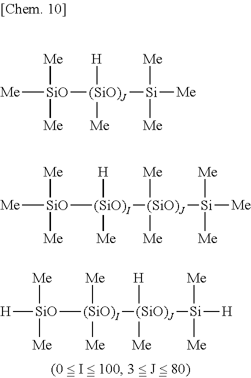

Component (C) is generally prepared by ring-opening polymerization of a cyclic low-molecular-weight siloxane such as octamethylcyclotetrasiloxane with a siloxane having a SiH group such as tetramethylcyclotetrasiloxane in the presence of an acid catalyst. Since the reaction product after polymerization contains the reactant, cyclic low-molecular-weight siloxane, the reaction product is preferably used after the reactant is distilled off at elevated temperature and reduced pressure while passing an inert gas through the reaction product.

Component (C) is blended in such an amount that a molar ratio of Si—H groups in component (C) to the total of alkenyl groups in components (A) and (B) (designated Si—H/alkenyl ratio) ranges from 0.5/1 to 30/1, and preferably 1 to 25. A molar ratio of less than 0.5 leads to insufficient cure whereas a molar ratio in excess of 30 provides a primer composition having poor adhesion with a lapse of time.

### [Component (D)]

Component (D) is a platinum group metal based catalyst for promoting hydrosilylation addition reaction between alkenyl groups in components (A) and (B) and Si—H groups in component (C) and optional component (G) for curing. Examples of the center metal of the catalyst include platinum group metals such as platinum, palladium, iridium, rhodium, osmium, and ruthenium, with platinum being most preferred. Suitable platinum catalysts include chloroplatinic acid, alcohol solutions of chloroplatinic acid, the reaction products of chloroplatinic acid with alcohols, the reaction products of chloroplatinic acid with olefins, and the reaction products of chloroplatinic acid with vinyl-containing siloxanes.

Component (D) is preferably blended in such an amount as to give 1 to 500 ppm, more preferably 2 to 450 ppm of metal (available from the platinum group metal catalyst) based on the weight of component (A). A metal content of less than 1 ppm may lead to slow reaction and under-cure. If the metal content exceeds 500 ppm, the treating bath may become so reactive as to shorten the work life and to interfer with effective coating.

### [Component (E)]

Component (E) is a reaction regulator. It is added for preventing the addition reaction from starting prior to heat curing and preventing the treating solution from thickening or gelling when a composition is prepared and cured onto a substrate to form a PSA layer. The reaction regulator coordinates with the platinum group metal of the addition reaction catalyst to control addition reaction, but when heated for curing, releases the coordination, allowing the catalytic activity to develop. As the reaction regulator, any of reaction regulators which are commonly used in addition reaction cure type silicone compositions may be used. Suitable examples include 3-methyl-1-butyn-3-ol, 3-methyl-1-pentyn-3-ol, 3,5-dimethyl-1-hexyn-3-ol, 1-ethynylcyclohexanol, 3-methyl-3-trimethyl siloxy-1-butyne, 3-methyl-3 -trimethylsiloxy-1-pentyne, 3,5-dimethyl-3-trimethylsiloxy-1-hexyne, 1-ethynyl-1-trimethylsiloxycyclohexane, bis(2,2-dimethyl-3-butynoxy)dimethylsilane, 1,3,5,7-tetramethyl-1,3,5,7-tetravinylcyclotetrasiloxane, 1,1,3,3-tetramethyl-1,3-divinyldisiloxane, maleic esters, and adipic esters.

Component (E) is preferably blended in an amount of 0.01 to 5 parts by weight, more preferably 0.05 to 2 parts by weight per 100 parts by weight of components (A) to (C) combined. Less than 0.01 part of component (E) may fail to control the reaction and allow the composition to cure prior to working whereas more than 5 parts may retard the reaction, resulting in insufficient cure.

### [Component (F)]

Component (F) is a silane coupling agent. Component (F), if blended, achieves a better bond between a cured product after curing of the inventive composition and a silicone PSA. A compound having the general formula (3) may be used as component (F).

R³ᵢSi(OR⁴)₄₋ᵢ (3)

Herein R³ is a monovalent organic group free of nitrogen, sulfur, phosphor and tin elements, R⁴ is C₁-C₄ alkyl such as methyl, ethyl, propyl or butyl, and i is a number 1≤i≤3, preferably 1 or 2, more preferably 1.

In formula (3), R³ is a monovalent organic group free of nitrogen, sulfur, phosphor and tin elements, examples of which include substituted or unsubstituted C₁-C₁₀, especially C₁-C₈ monovalent hydrocarbon groups free of aliphatic unsaturation, C₂-C₁₀, especially C₂-C₈ alkenyl-containing organic groups, and C₂-C_{10,} especially C₃-C₈ epoxy-containing organic groups.

Examples of the substituted or unsubstituted monovalent hydrocarbon group free of aliphatic unsaturation, represented by R³, include alkyl groups such as methyl, ethyl, propyl and butyl, cycloalkyl groups such as cyclohexyl, aryl groups such as phenyl, and substituted forms of the foregoing in which some or all carbon-bonded hydrogen atoms are substituted by halogen atoms, such as trifluoromethyl and 3,3,3-trifluoropropyl.

Examples of the alkenyl-containing organic group, represented by R³, include alkenyl groups such as vinyl, allyl, hexenyl and octenyl, acryloylalkyl and methacryloylalkyl groups such as acryloylpropyl, acryloylmethyl, and methacryloylpropyl, cycloalkenylalkyl groups such as cyclohexenylethyl, and alkenyloxyalkyl groups such as vinyloxypropyl.

Examples of the epoxy-containing organic group, represented by R³, include the structures shown below.

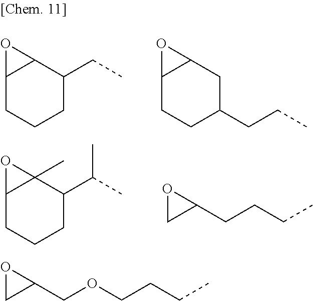

Herein the broken line designates a valence bond.

Illustrative structures of component (F) are shown below, but not limited thereto. Notably, Me stands for methyl, Et for ethyl, Vi for vinyl, and Ph for phenyl.

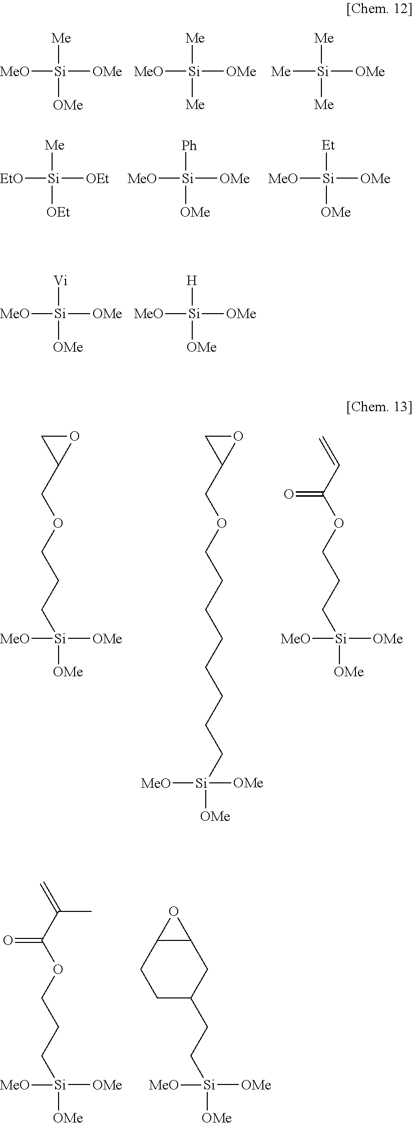

When blended, the amount of component (F) is preferably 0.5 to 10 parts by weight, more preferably 1 to 8 parts by weight per 100 parts by weight of component (A). Too much amounts of component (F) may adversely affect the cure of the primer composition whereas too less amounts may fail to obtain a sufficient primer effect.

### [Component (G)]

Component (G) is a compound having the general formula (4) or (5) shown below. It is an optional component which is added in order to further improve the adhesion between the primer composition and the silicone PSA. Notably, component (G) is different from components (A) and (B) in that it is alkenyl-free and from component (C) in that it contains an alkoxy or epoxy group.

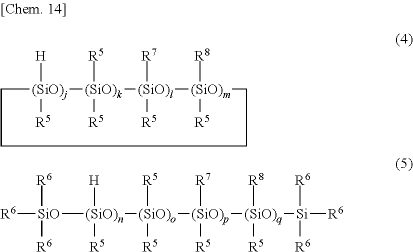

Herein R⁵ which may be the same or different is a substituted or unsubstituted C₁-C₁₀ monovalent hydrocarbon group free of aliphatic unsaturation, R⁶ is hydrogen or R⁵, R⁷ is an epoxy-containing organic group, R⁸ is an alkoxysilyl-containing organic group, j and n each are an integer of at least l, k and o each are an integer of at least 0, l, m, p and q each are an integer of at least 0, l+m and p+q each are an integer of at least 1.

In formulae (4) and (5), R⁵ is a substituted or unsubstituted C₁-C₁₀, especially C₁-C₈ monovalent hydrocarbon group free of aliphatic unsaturation. Examples include alkyl groups such as methyl, ethyl, propyl and butyl, cycloalkyl groups such as cyclohexyl, aryl groups such as phenyl, and substituted forms of the foregoing in which some or all carbon-bonded hydrogen atoms are substituted by halogen atoms, such as trifluoromethyl and 3,3,3-trifluoropropyl. Methyl is most preferred.

R⁷ is an epoxy-containing organic group, examples of which include C₃-C₁₂, especially C₄-C₁₀ groups as shown below.

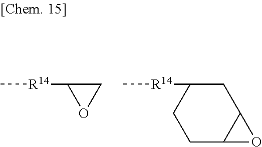

Herein R¹⁴ is a C₁-C₆, preferably C₂-C₄ alkylene group which may be separated by an oxygen atom (or oxyalkylene group), and the broken line designates a valence bond.

Exemplary are epoxy-containing alkyl groups as shown below.

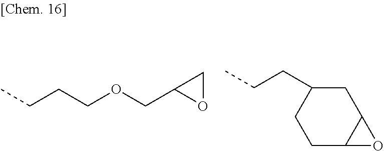

Herein the broken line designates a valence bond.

R⁸ is an alkoxysilyl-containing organic group. Typical are alkoxysilyl-containing alkyl groups as shown below.

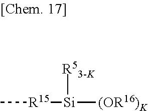

Herein R¹⁵ is a C₁-C₆, preferably C₂-C₄ alkylene group, R¹⁶ is a C₁-C₆ alkyl group, R⁵ is as defined above, K is an integer of 1 to 3, preferably 2 or 3, and the broken line designates a valence bond.

Illustrative examples are shown below. Notably, Me stands for methyl, and Et for ethyl.

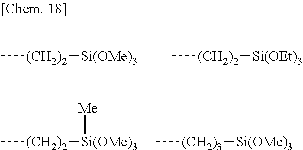

The subscripts j and n each are an integer of at least 1, preferably 1 to 8, k and o each are an integer of at least 0, preferably 0 to 2, l, m, p and q each are an integer of at least 0, preferably l is 0, 1 or 2, m is 0, 1 or 2, p is 0, 1 or 2, q is 0, 1 or 2, l+m and p+q each are an integer of at least 1, preferably 1 or 2.

Also preferably, j+k+l+m is an integer of 3 to 8, especially 4 to 6, and n+o+p+q is an integer of 3 to 8, especially 4 to 6.

Examples of component (G) are shown below, but not limited thereto. Notably, Me stands for methyl.

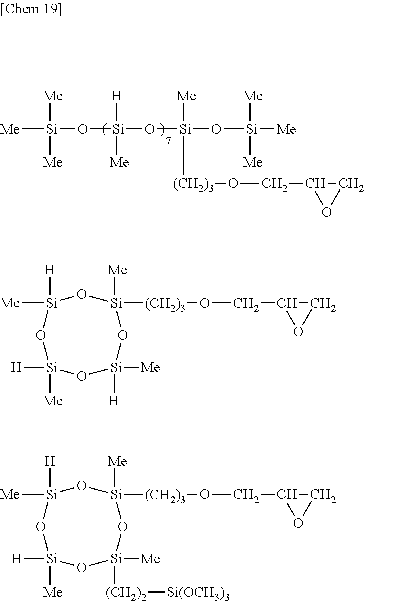

When blended, the amount of component (G) is preferably 0.1 to 10 parts by weight, more preferably 0.2 to 8 parts by weight, even more preferably 0.3 to 5 parts by weight per 100 parts by weight of component (A). Less than 0.1 part of component (G) may fail to obtain a sufficient primer effect whereas more than 10 parts may be detrimental to the cure of the primer composition.

### [Component (H)]

Component (H) is an organic solvent. It is an optional component which is used to reduce the viscosity of the composition for improving workability and to improve wetting when coated to a substrate. Examples of the organic solvent include aromatic hydrocarbon solvents such as toluene and xylene; aliphatic hydrocarbon solvents such as hexane, heptane, octane, isooctane, decane, cyclohexane, methylcyclohexane, and isoparaffin; other hydrocarbon solvents such as industrial gasoline (or rubber solvent), petroleum benzine, and solvent naphtha; ketone solvents such as acetone, methyl ethyl ketone, 2-pentanone, 3-pentanone, 2-hexanone, 2-heptanone, 4-heptanone, methyl isobutyl ketone, diisobutyl ketone, acetonylacetone, and cyclohexanone; ester solvents such as ethyl acetate, propyl acetate, isopropyl acetate, butyl acetate, and isobutyl acetate; ether solvents such as diethyl ether, dipropyl ether, diisopropyl ether, dibutyl ether, 1,2-dimethoxyethane, and 1,4-dioxane; solvents having ester and ether moieties such as 2-methoxyethyl acetate, 2-ethoxyethyl acetate, propylene glycol monomethyl ether acetate, and 2-butoxyethyl acetate;

siloxane solvents such as hexamethyldisiloxane, octamethyltrisiloxane, octamethylcyclotetrasiloxane, decamethylcyclopentasiloxane, tris(trimethylsiloxy)methylsilane, and tetrakis(trimethylsiloxy)silane; and fluorochemical solvents such as trifluorotoluene, hexafluoroxylene, methyl nonafluorobutyl ether, ethyl nonafluorobutyl ether, and mixtures thereof. Of these, industrial gasoline (or rubber solvent) and isoparaffin are preferably used.

The amount of component (H) added is 0 to 2,000 parts by weight, preferably 0 to 1,500 parts by weight, more preferably 0 to 1,000 parts by weight per 100 parts by weight of component (A). More than 2,000 parts of component (H) may adversely affect coating. When used, the amount of component (H) is preferably at least 5 parts by weight per 100 parts by weight of component (A).

A surface-treated substrate is provided by coating the inventive primer composition for silicone PSA to a substrate and curing the composition to form a cured coating on the substrate surface. The surface-treated substrate has improved adhesion to silicone PSA.

The substrate to which the primer composition is coated may be selected from paper, plastic film, glass, and metals. Examples of paper include wood-free paper, coated paper, art paper, glassine paper, polyethylene-laminated paper, and kraft paper. Suitable plastic films include polyethylene film, polypropylene film, polyester film, polyimide film, polyvinyl chloride film, polyvinylidene chloride film, polyvinyl alcohol film, polycarbonate film, polytetrafluoroethylene film, polystyrene film, ethylene-vinyl acetate copolymer film, ethylene-vinyl alcohol copolymer film, triacetylcellulose film, polyether ether ketone film, and polyphenylene sulfide film. The glass used herein is not particularly limited with respect to the thickness and type, and chemically strengthened glass is acceptable. Also useful are glass fibers which may be used alone or as composites with resins. Suitable metals include aluminum foil, copper foil, gold foil, silver foil, and nickel foil. Of these, polyester film and polyimide film are preferred in an application where the primer composition is coated and cured before a silicone PSA composition is coated thereon.

Any known means or method for application may be used in coating the substrate with the primer composition. For example, a wire bar, comma coater, lip coater, roll coater, die coater, knife coater, blade coater, rod coater, kiss-roll coater, and gravure coater are acceptable as well as screen printing, dipping, and casting methods.

The coating weight of the primer composition on a substrate is preferably in the range of 0.1 to 2 g/m², especially 0.2 to 1.8 g/m², calculated as solids. Curing conditions include heating at 80 to 180° C., especially 100 to 160° C. for 10 seconds to 10 minutes, especially 30 seconds to 8 minutes, but are not limited thereto.

A PSA article is provided by coating a silicone PSA composition on the surface of a substrate which has been treated with the primer composition and curing the PSA composition. The PSA article has improved adhesion between the substrate and the silicone PSA.

The silicone PSA composition used herein is preferably an addition curable organopolysiloxane composition adapted to cure with the aid of a platinum base catalyst. Specifically, it is a silicone PSA composition comprising components (I), (J), (C), (D), and (E). Components (I) and (J) will be described below, and components (C), (D), and (E) are as described above.

### [Component (I)]

Component (I) is an organopolysiloxane having at least two alkenyl-containing organic groups per molecule. One illustrative structure is represented by the average compositional formula (8).

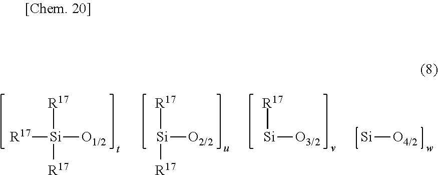

Herein R¹⁷ which may be the same or different is a substituted or unsubstituted C₁-C₁₀ monovalent hydrocarbon group free of aliphatic unsaturation or a C₂-C₁₀ alkenyl-containing organic group, at least two of R¹⁷ containing a C₂-C₁₀ alkenyl-containing organic group, t is an integer of at least 2, u is an integer of at least 1, v is an integer of at least 0, w is an integer of at least 0, and 50≤t+u+v+w≤12,000.

In formula (8), R¹⁷ is a substituted or unsubstituted C₁-C_{10,} especially C₁-C₈ monovalent hydrocarbon group free of aliphatic unsaturation or a C₂-C_{10,} especially C₂-C₈ alkenyl-containing organic group, at least two of groups R¹⁷ are C₂-C₁₀ alkenyl-containing organic groups.

Examples of the substituted or unsubstituted monovalent hydrocarbon group free of aliphatic unsaturation, represented by R¹⁷, include alkyl groups such as methyl, ethyl, propyl and butyl, cycloalkyl groups such as cyclohexyl, aryl groups such as phenyl, and substituted forms of the foregoing groups in which some or all carbon-bonded hydrogen atoms are substituted by halogen atoms, such as trifluoromethyl and 3,3,3-trifluoropropyl. Inter alia, methyl and phenyl are most preferred.

Examples of the alkenyl-containing organic groups, represented by R¹⁷, include alkenyl groups such as vinyl, allyl, hexenyl and octenyl, acryloylalkyl and methacryloylalkyl groups such as acryloylpropyl, acryloylmethyl, and methacryloylpropyl, cycloalkenylalkyl groups such as cyclohexenylethyl, and alkenyloxyalkyl groups such as vinyloxypropyl. Inter alia, vinyl is most preferred.

In formula (8), t is an integer of at least 2, preferably 2 to 6, u is an integer of at least 1, preferably 34 to 11,998, v and w each are an integer of at least 0, preferably 0 to 5, and 50≤t+u+v+w≤12,000, preferably 100≤t+u+v+w≤10,000. If t+u+v+w is less than 50, reactivity may lower due to too much crosslinking points. If t+u+v+w exceeds 12,000, the composition may have an extremely high viscosity so that the composition may become difficult to agitate and mix and inefficient to work.

The content of alkenyl groups in component (I) is preferably 0.0005 to 0.05 mole, more preferably 0.0006 to 0.04 mole, even more preferably 0.0007 to 0.03 mole per 100 g of the organopolysiloxane. An alkenyl content of less than 0.0005 mole may lead to a lower crosslinking density, allowing the PSA layer to undergo cohesive failure. An alkenyl content in excess of 0.05 mole may lead to a harder PSA layer, failing to gain an adequate bonding force or tack.

Examples of component (I) include those of the following general formulae, but are not limited thereto.

R¹⁷⁻¹R¹⁷⁻²₂SiO(R¹⁷⁻²₂SiO)_{L}SiR¹⁷⁻²₂R¹⁷⁻¹ (v)

R¹⁷⁻¹R¹⁷⁻²₂SiO(R¹⁷⁻²₂SiO)_{L}(R¹⁷⁻²R¹⁷⁻²SiO)_{M}SiR¹⁷⁻²₂R¹⁷⁻¹ (vi)

R¹⁷⁻¹₃SiO(R¹⁷⁻²₂SiO)_{L}(R¹⁷⁻¹R¹⁷⁻²SiO)_{M}SiR¹⁷⁻¹₃ (vii)

R¹⁷⁻²₃SiO(R¹⁷⁻²₂SiO)_{L}(R¹⁷⁻¹R¹⁷⁻²SiO)_{M}SiR¹⁷⁻²₃ (viii)

Herein R¹⁷⁻¹ which may be the same or different is a C₂-C₁₀ alkenyl-containing organic group, R¹⁷⁻² which may be the same or different is a substituted or unsubstituted C₁-C₁₀ monovalent hydrocarbon group free of aliphatic unsaturation. In formula (v), L≥48, and in formulae (vi), (vii) and (viii), L+M≥48 and M≥1, with the proviso that M≥2 where no R¹⁷⁻¹ is contained in the molecule, but (R¹⁷⁻¹R¹⁷⁻²SiO)_{M}.

Examples of R¹⁷⁻¹ and R¹⁷⁻² are as exemplified above for R¹⁷. In formula (v), L is preferably 48≤L≤11,998, more preferably 98≤L≤9,998. In formulae (vi), (vii) and (viii), L and M are preferably 48≤L+M≤11,998, more preferably 98≤L+M≤9,998, and 1≤M≤1,000, more preferably 2≤M≤800.

More illustrative examples of component (I) include those of the following general formulae, but are not limited thereto. Notably, Me stands for methyl, Vi for vinyl, and Ph for phenyl.

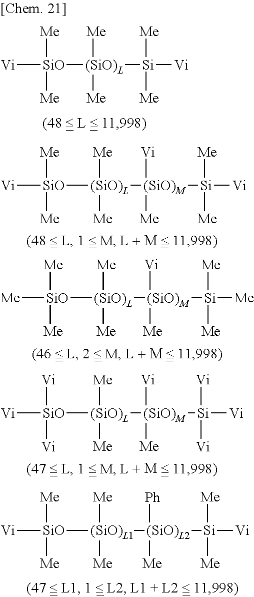

Component (I) is generally prepared by ring-opening polymerization of a cyclic low-molecular-weight siloxane such as octamethylcyclotetrasiloxane with a cyclic low-molecular-weight siloxane having an alkenyl-containing organic group in the presence of a catalyst. Since the reaction product after polymerization contains the reactants, cyclic low-molecular-weight siloxanes, the reaction product is preferably used after the reactants are distilled off at elevated temperature and reduced pressure while passing an inert gas through the reaction product.

### [Component (J)]

Component (J) is a polyorganosiloxane comprising R¹⁸₃SiO_{1/2} units and SiO_{4/2} units wherein R¹⁸ is each independently a C₁-C₁₀ monovalent hydrocarbon group free of aliphatic unsaturation or a C₂-C₆ alkenyl group wherein a molar ratio of R¹⁸₃SiO_{1/2} units to SiO_{4/2} units ranges from 0.5/1 to 1.0/1. If the molar ratio is less than 0.5, there may be a drop of bonding force or tack. If the molar ratio exceeds 1.0, there may be a drop of bonding or retaining force. The molar ratio is preferably from 0.6 to 0.9.

R¹⁸ is each independently a C₁-C₁₀ monovalent hydrocarbon group free of aliphatic unsaturation or a C₂-C₆ alkenyl group. Preferred C₁-C₁₀ monovalent hydrocarbon groups free of aliphatic unsaturation include C₂-C₆ alkyl groups such as methyl, ethyl, propyl and butyl, and C₆-C₁₀ aryl groups such as phenyl and tolyl. Preferred C₂-C₆ alkenyl groups include vinyl, allyl and butenyl.

In addition to R¹⁸, component (J) may contain a silanol group and/or a hydrolyzable alkoxy group, and if so, preferably in an amount of 0.01 to 4%, more preferably 0.05 to 3.5% by weight based on the total weight of component (J). If the content of silanol or alkoxy group is less than 0.01 wt %, there may occur a loss of cohesion of PSA. A content in excess of 4 wt % may result in a loss of tack of PSA. Suitable alkoxy groups include methoxy, ethoxy, isopropoxy, butoxy and phenoxy. When the alkoxy group is contained, methoxy is preferred.

Component (J) may be a mixture of two or more polyorganosiloxanes. Unlike component (I), R¹⁸₂SiO_{2/2} units and/or R¹⁸SiO_{3/2} units may be incorporated in component (J) in such an amount that the total of R¹⁸₂SiO_{2/2} units and R¹⁸SiO_{3/2} units may be 0 to 20 mol %, especially 0 to 10 mol % based on the total of R¹₃SiO_{1/2} units and SiO_{4/2} units insofar as they do not adversely impact the properties of the composition.

Component (J) may be obtained from condensation reaction in the presence of a catalyst. This is the reaction of hydrolyzable groups available on the surface, from which effects such as improvement in bonding force are expectable. Reaction is performed in the presence of an alkaline catalyst at room temperature to reflux temperature and may be followed by neutralization if necessary. Also, this step may be performed in the co-presence of component (I).

Suitable alkaline catalysts include metal hydroxides such as lithium hydroxide, sodium hydroxide, potassium hydroxide, and calcium hydroxide; carbonates such as sodium carbonate and potassium carbonate; hydrogencarbonates such as sodium hydrogencarbonate and potassium hydrogencarbonate; metal alkoxides such as sodium methoxide and potassium butoxide; organometallic compounds such as butyl lithium; potassium silanolate; and nitrogen compounds such as ammonia gas, aqueous ammonia, methylamine, trimethylamine, and triethylamine. Inter alia, ammonia gas and aqueous ammonia are preferred. The temperature of condensation reaction may range from room temperature to the reflux temperature of an organic solvent. The reaction time may be 0.5 to 20 hours, preferably 1 to 16 hours, though not particularly limited. At the end of reaction, a neutralizing agent may be added for neutralizing the alkaline catalyst, if necessary.

Suitable neutralizing agents include acidic gases such as hydrogen chloride and carbon dioxide, organic acids such as acetic acid, octylic acid, and citric acid, and mineral acids such as hydrochloric acid, sulfuric acid and phosphoric acid. Where ammonia gas, aqueous ammonia or low-boiling amine compound is used as the alkaline catalyst, an inert gas such as nitrogen may be bubbled to distill off the catalyst.

Provided that the total of components (I) and (J) is 100 parts by weight, the amount of component (I) used is 100 to 30 parts by weight and the amount of component (J) is 70 to 0 part by weight, which means that component (J) may be omitted in some cases. The weight ratio of component (I) to component (J) is in the range of from 100/0 to 30/70, and preferably from 100/0 to 35/65.

In the silicone PSA composition, component (C) or organohydrogenpolysiloxane having at least 3 Si—H groups per molecule is preferably used in such an amount that the molar ratio of Si—H groups in component (C) to the total of alkenyl groups in components (I) and (J), i.e., SiH/alkenyl ratio is in the range of 0.5/1 to 30/1, more preferably 1 to 25. If the ratio is less than 0.5, crosslinking density may be too low to provide PSA properties, as demonstrated by a loss of retaining force. If the ratio exceeds 30, bonding force and tack may become low and the treating bath have a short work life.

In the silicone PSA composition, component (D) or platinum group metal base catalyst is used in an amount to give 1 to 500 ppm, preferably 5 to 400 ppm of metal (available from the platinum group metal base catalyst) based on the total weight of components (I) and (J). With less than 1 ppm of metal, the PSA may not cure to a full extent. With more than 500 ppm of metal, the treating bath may have a short work life.

In the silicone PSA composition, component (E) or reaction regulator is preferably used in an amount of 0.01 to 5 parts by weight, more preferably 0.05 to 2 parts by weight per 100 parts by weight of components (I), (J) and (C) combined. Less than 0.01 part of component (E) may be ineffective for controlling the reaction, allowing the composition to cure before application. An amount in excess of 5 parts may retard the reaction, resulting in undercure.

Where the silicone PSA composition prepared by blending the above components is highly viscous and difficult to handle, the composition may be diluted with a suitable organic solvent. The organic solvent used herein may be the same as component (H). The amount of the organic solvent blended is 0 to 2,000 parts by weight, preferably 0 to 1,500 parts by weight, more preferably 0 to 1,000 parts by weight per 100 parts by weight of component (I). More than 2,000 parts of the solvent may adversely affect the coating operation. When the organic solvent is used, its amount is preferably at least 10 parts by weight per 100 parts by weight of component (I).

The silicone PSA composition may be prepared by mixing the above components until uniform. In general, the catalyst is uniformly mixed immediately before the silicone PSA composition is used.

Any known means or method for application may be used in coating the substrate with the silicone PSA composition. For example, an applicator, wire bar, comma coater, lip coater, roll coater, die coater, knife coater, blade coater, rod coater, kiss-roll coater, and gravure coater may be used as well as screen printing, dipping, and casting methods.

The PSA layer as cured may have a thickness of 1 to 500 μm although the thickness is not limited thereto. The composition may be cured at a temperature of 80 to 180° C., especially 100 to 160° C. for 10 seconds to 10 minutes, especially 30 seconds to 8 minutes although the curing conditions are not limited thereto.

### EXAMPLES

Examples and Comparative Examples are given below for further illustrating the invention although the invention is not limited thereto. In Examples, “Me” stands for methyl, “Vi” for vinyl, “Et” for ethyl, and “Ph” for phenyl.

### <Primer Cure>

A primer composition for silicone PSA was coated onto a polyethylene terephthalate (PET) of 25 μm thick and 25 mm wide by means of a wire bar so as to give a solid weight of 0.5 g/m² after curing, and air dried at 130° C. for 1 minute. The primer-treated substrate was evaluated for cure by touching the silicone coated surface with the finger.

○: no finger marks left

x: finger marks left

### <Adhesion>

A tape sample was prepared by coating a silicone PSA composition on the primer-treated substrate (prepared as above) by means of an applicator so as to give a thickness of 30 μm after curing, and curing at 130° C. for 1 minute. Lateral portions of 2 mm were cut off from the tape sample. After the tape sample was torn and pulled from the opposite ends, it was visually observed whether or not the PSA layer was separated apart from the substrate, and evaluated as follows.

○: not separated

x: separated apart

### <Elongation>

In the adhesion test, the tape sample was torn, after which the tape sample with the substrate separated was further pulled. The distance (mm) by which the PSA layer was elongated was measured. A smaller distance indicates better adhesion.

It is noted that the tape sample was evaluated for adhesion and elongation at two levels where the primer composition was cured for 1 minute and 5 minutes.

### Example 1

### Preparation of Primer Composition for Silicone PSA

A primer composition 1 for silicone PSA was prepared by mixing 100 parts by weight of a dimethylpolysiloxane containing 0.00245 mole/100 g of vinyl and having the average compositional formula (a-1):

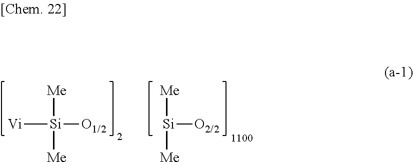

as component (A), 3 parts by weight of a dimethylpolysiloxane containing 0.2160 mole/100 g of vinyl and having the average compositional formula (b-1):

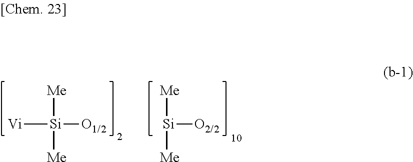

as component (B), 0.97 part by weight of a methylhydrogenpolysiloxane having the average compositional formula (c-1):

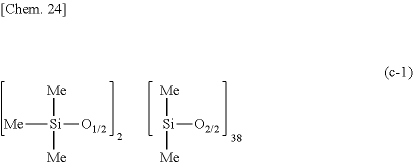

as component (C), 0.60 part by weight of ethynylcyclohexanol as component (E), and 242.00 parts by weight of rubber solvent as component (H), to form a liquid mixture containing 30 wt % of solids, adding 0.5 part by weight of a toluene solution of 1,3-divinyl-1,1,3,3-tetramethyldisiloxane platinum(0) complex containing 0.5 wt % of platinum to the mixture, and diluting the mixture with a solvent of hexane and methyl ethyl ketone in a weight ratio of 1:1 so as to give 5 wt % of solids. The molar ratio of Si—H groups in component (C) to the total of vinyl groups in components (A) and (B) was 1.7/1.

### Preparation of Silicone PSA Composition

A composition was prepared by mixing 35 parts by weight of dimethylpolysiloxane (containing 0.00091 mole/100 g of vinyl) having the average compositional formula (i-1):

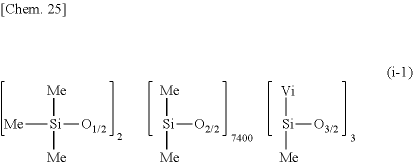

as component (I), 65 parts by weight (calculated as nonvolatile) of a 60 wt % toluene solution of methylpolysiloxane consisting of Me₃SiO_{1/2} units and SiO₂ units in a molar ratio (Me₃SiO_{1/2}/SiO₂) of 0.85 as component (J), 0.23 part by weight of methylhydrogenpolysiloxane having formula (c-1) as component (C), and 0.25 part by weight of ethynylcyclohexanol as component (E) and diluting with toluene so that the composition had a solid content of 60 wt %. A silicone PSA composition was prepared by adding 50 parts by weight of toluene to 100 parts by weight of the resulting composition, and further adding 0.5 part by weight of a toluene solution of 1,3-divinyl-1,1,3,3-tetramethyldisiloxane platinum(0) complex containing 0.5 wt % of platinum as component (D) thereto. The molar ratio of Si—H groups in component (C) to vinyl groups in component (I) was 11.4/1.

These compositions prepared as above were evaluated for primer cure, adhesion and elongation by the above methods. The results are shown in Table 1.

### Example 2

A primer composition 2 for silicone PSA was prepared as in Example 1 aside from using 5 parts by weight of dimethylpolysiloxane having formula (b-1) as component (B), 1.44 parts by weight of methylhydrogenpolysiloxane having formula (c-1) as component (C), and 247.76 parts by weight of rubber solvent as component (H). The molar ratio of Si—H groups in component (C) to the total of vinyl groups in components (A) and (B) was 1.7/1.

The primer cure, adhesion and elongation were evaluated as in Example 1 aside from using primer composition 2. The results are shown in Table 1.

### Example 3

A primer composition 3 for silicone PSA was prepared as in Example 1 aside from using 10 parts by weight of dimethylpolysiloxane having formula (b-1) as component (B), 2.62 parts by weight of methylhydrogenpolysiloxane having formula (c-1) as component (C), and 262.18 parts by weight of rubber solvent as component (H). The molar ratio of Si—H groups in component (C) to the total of vinyl groups in components (A) and (B) was 1.7/1.

The primer cure, adhesion and elongation were evaluated as in Example 1 aside from using primer composition 3. The results are shown in Table 1.

### Example 4

A primer composition 4 for silicone PSA was prepared as in Example 1 aside from using 3 parts by weight of a dimethylpolysiloxane (containing 0.4190 mole/100 g of vinyl) having the average compositional formula (b-2):

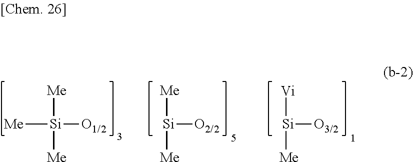

as component (B), 1.64 parts by weight of methylhydrogenpolysiloxane having formula (c-1) as component (C), and 243.56 parts by weight of rubber solvent as component (H). The molar ratio of Si—H groups in component (C) to the total of vinyl groups in components (A) and (B) was 1.7/1.

The primer cure, adhesion and elongation were evaluated as in Example 1 aside from using primer composition 4. The results are shown in Table 1.

### Example 5

A primer composition 5 for silicone PSA was prepared as in Example 1 aside from using 3 parts by weight of a dimethylpolysiloxane (containing 1.1628 mole/100 g of vinyl) having the average compositional formula (b-3):

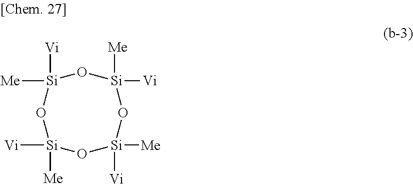

as component (B), 4.07 parts by weight of methylhydrogenpolysiloxane having formula (c-1) as component (C), and 249.23 parts by weight of rubber solvent as component (H). The molar ratio of Si—H groups in component (C) to the total of vinyl groups in components (A) and (B) was 1.7/1.

The primer cure, adhesion and elongation were evaluated as in Example 1 aside from using primer composition 5. The results are shown in Table 1.

### Example 6

A primer composition 6 for silicone PSA was prepared as in Example 1 aside from using 100 parts by weight of a dimethylpolysiloxane (containing 0.00364 mole/100 g of vinyl) having the average compositional formula (a-2):

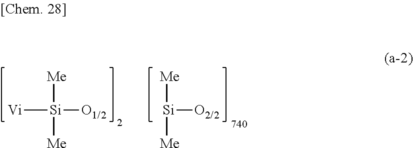

as component (A), 1.10 parts by weight of methylhydrogenpolysiloxane having formula (c-1) as component (C), and 242.30 parts by weight of rubber solvent as component (H). The molar ratio of Si—H groups in component (C) to the total of vinyl groups in components (A) and (B) was 1.7/1.

The primer cure, adhesion and elongation were evaluated as in Example 1 aside from using primer composition 6. The results are shown in Table 1.

### Example 7

A primer composition 7 for silicone PSA was prepared as in Example 1 aside from using 100 parts by weight of a dimethylpolysiloxane (containing 0.00527 mole/100 g of vinyl) having the average compositional formula (a-3):

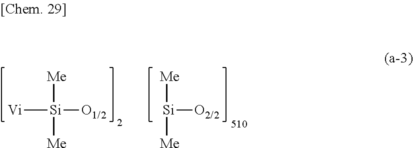

as component (A), 1.28 parts by weight of methylhydrogenpolysiloxane having formula (c-1) as component (C), and 242.72 parts by weight of rubber solvent as component (H). The molar ratio of Si—H groups in component (C) to the total of vinyl groups in components (A) and (B) was 1.7/1.

The primer cure, adhesion and elongation were evaluated as in Example 1 aside from using primer composition 7. The results are shown in Table 1.

### Example 8

A primer composition 8 for silicone PSA was prepared as in Example 1 aside from further adding 1.0 part by weight of a compound having the following formula (f-1) as component (F). The molar ratio of Si—H groups in component (C) to the total of vinyl groups in components (A) and (B) was 1.7/1.

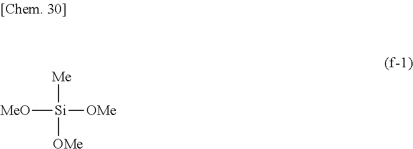

The primer cure, adhesion and elongation were evaluated as in Example 1 aside from using primer composition 8. The results are shown in Table 1.

### Example 9

A primer composition 9 for silicone PSA was prepared as in Example 1 aside from further adding 1.0 part by weight of a compound having the following formula (f-2) as component (F). The molar ratio of Si—H groups in component (C) to the total of vinyl groups in components (A) and (B) was 1.7/1.

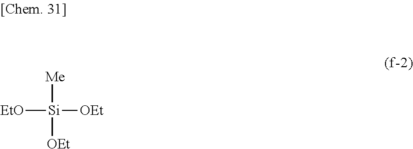 [SMILES: CCO[Si](C)(OCC)OCC]

The primer cure, adhesion and elongation were evaluated as in Example 1 aside from using primer composition 9. The results are shown in Table 1.

### Example 10

A primer composition 10 for silicone PSA was prepared as in Example 1 aside from further adding 1.0 part by weight of a compound having the following formula (f-3) as component (F). The molar ratio of Si—H groups in component (C) to the total of vinyl groups in components (A) and (B) was 1.7/1.

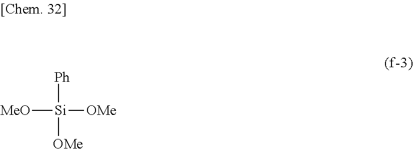 [SMILES: CO[Si](OC)(OC)c1ccccc1]

The primer cure, adhesion and elongation were evaluated as in Example 1 aside from using primer composition 10. The results are shown in Table 1.

### Example 11

A primer composition 11 for silicone PSA was prepared as in Example 1 aside from further adding 1.0 part by weight of a compound having the following formula (f-4) as component (F). The molar ratio of Si—H groups in component (C) to the total of vinyl groups in components (A) and (B) was 1.7/1.

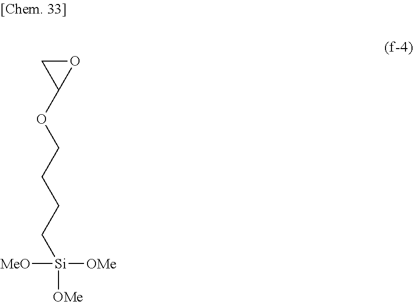 [SMILES: CO[Si](CCCCOC1CO1)(OC)OC]

The primer cure, adhesion and elongation were evaluated as in Example 1 aside from using primer composition 11. The results are shown in Table 1.

### Example 12

A primer composition 12 for silicone PSA was prepared as in Example 1 aside from further adding 1.0 part by weight of a compound having the following formula (f-5) as component (F). The molar ratio of Si—H groups in component (C) to the total of vinyl groups in components (A) and (B) was 1.7/1.

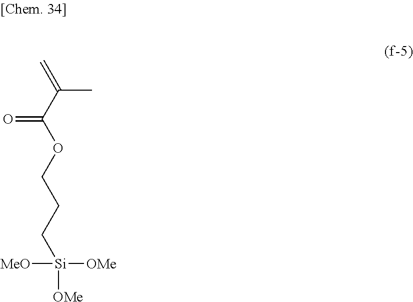 [SMILES: C=C(C)C(=O)OCCC[Si](OC)(OC)OC]

The primer cure, adhesion and elongation were evaluated as in Example 1 aside from using primer composition 12. The results are shown in Table 1.

### Example 13

A primer composition 13 for silicone PSA was prepared as in Example 8 aside from using 3.0 parts by weight of the compound having formula (f-1) as component (F). The molar ratio of Si—H groups in component (C) to the total of vinyl groups in components (A) and (B) was 1.7/1.

The primer cure, adhesion and elongation were evaluated as in Example 1 aside from using primer composition 13. The results are shown in Table 1.

### Example 14

A primer composition 14 for silicone PSA was prepared as in Example 8 aside from using 5.0 parts by weight of the compound having formula (f-1) as component (F). The molar ratio of Si—H groups in component (C) to the total of vinyl groups in components (A) and (B) was 1.7/1.

The primer cure, adhesion and elongation were evaluated as in Example 1 aside from using primer composition 14. The results are shown in Table 1.

### Example 15

A primer composition 15 for silicone PSA was prepared as in Example 4 aside from using 1.0 part by weight of the compound having formula (f-1) as component (F). The molar ratio of Si—H groups in component (C) to the total of vinyl groups in components (A) and (B) was 1.7/1.

The primer cure, adhesion and elongation were evaluated as in Example 1 aside from using primer composition 15. The results are shown in Table 1.

### Example 16

A primer composition 16 for silicone PSA was prepared as in Example 5 aside from using 1.0 part by weight of the compound having formula (f-1) as component (F). The molar ratio of Si—H groups in component (C) to the total of vinyl groups in components (A) and (B) was 1.7/1.

The primer cure, adhesion and elongation were evaluated as in Example 1 aside from using primer composition 16. The results are shown in Table 1.

### Example 17

A primer composition 17 for silicone PSA was prepared as in Example 6 aside from using 1.0 part by weight of the compound having formula (f-1) as component (F). The molar ratio of Si—H groups in component (C) to the total of vinyl groups in components (A) and (B) was 1.7/1.

The primer cure, adhesion and elongation were evaluated as in Example 1 aside from using primer composition 17. The results are shown in Table 1.

### Example 18

A primer composition 18 for silicone PSA was prepared as in Example 7 aside from using 1.0 part by weight of the compound having formula (f-1) as component (F). The molar ratio of Si—H groups in component (C) to the total of vinyl groups in components (A) and (B) was 1.7/1.

The primer cure, adhesion and elongation were evaluated as in Example 1 aside from using primer composition 18. The results are shown in Table 1.

### Example 19

A primer composition 19 for silicone PSA was prepared as in Example 8 aside from further adding 0.60 part by weight of a siloxane compound having the following formula (g-1) as component (G) and using 243.40 parts by weight of rubber solvent as component (H). The molar ratio of Si—H groups in component (C) to the total of vinyl groups in components (A) and (B) was 1.7/1.

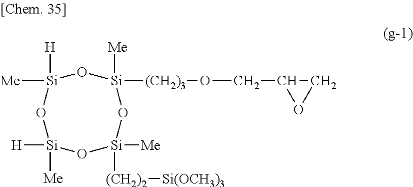

The primer cure, adhesion and elongation were evaluated as in Example 1 aside from using primer composition 19. The results are shown in Table 1.

### Example 20

A primer composition 20 for silicone PSA was prepared as in Example 8 aside from further adding 0.60 part by weight of a siloxane compound having the following formula (g-2) as component (G) and using 243.40 parts by weight of rubber solvent as component (H). The molar ratio of Si—H groups in component (C) to the total of vinyl groups in components (A) and (B) was 1.7/1.

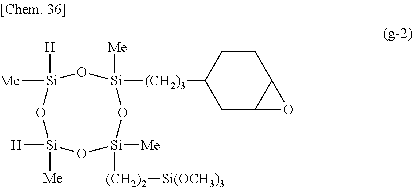

The primer cure, adhesion and elongation were evaluated as in Example 1 aside from using primer composition 20. The results are shown in Table 1.

### Comparative Example 1

A primer composition 21 for silicone PSA was prepared by mixing 100 parts by weight of dimethylpolysiloxane containing 0.00245 mole/100 g of vinyl and having formula (a-1) as component (A), 0.27 part by weight of methylhydrogenpolysiloxane having formula (c-1) as component (C), 0.60 part by weight of ethynylcyclohexanol as component (E), and 233.36 parts by weight of rubber solvent as component (H), to form a liquid mixture containing 30 wt % of solids, adding 0.5 part by weight of a toluene solution of 1,3-divinyl-1,1,3,3-tetramethyldisiloxane platinum(0) complex containing 0.5 wt % of platinum to the mixture, and diluting the mixture with a solvent of hexane and methyl ethyl ketone in a weight ratio of 1:1 so as to give a solid content of 5 wt %. The molar ratio of Si—H groups in component (C) to vinyl groups in component (A) was 1.7/1.

The primer cure, adhesion and elongation were evaluated as in Example 1 aside from using primer composition 21. The results are shown in Table 1.

### Comparative Example 2

A primer composition 22 for silicone PSA was prepared as in Comparative Example 1 aside from using 100 parts by weight of dimethylpolysiloxane having formula (a-2) as component (A), 0.40 part by weight of methylhydrogenpolysiloxane having formula (c-1) as component (C), and 233.67 parts by weight of rubber solvent as component (H). The molar ratio of Si—H groups in component (C) to vinyl groups in component (A) was 1.7/1.

The primer cure, adhesion and elongation were evaluated as in Example 1 aside from using primer composition 22. The results are shown in Table 1.

### Comparative Example 3

A primer composition 23 for silicone PSA was prepared as in Comparative Example 1 aside from using 100 parts by weight of dimethylpolysiloxane having formula (a-3) as component (A), 0.57 part by weight of methylhydrogenpolysiloxane having formula (c-1) as component (C), and 234.06 parts by weight of rubber solvent as component (H). The molar ratio of Si—H groups in component (C) to vinyl groups in component (A) was 1.7/1.

The primer cure, adhesion and elongation were evaluated as in Example 1 aside from using primer composition 23. The results are shown in Table 1.

### Comparative Example 4

A primer composition 24 for silicone PSA was prepared as in Comparative Example 1 aside from using 100 parts by weight of a dimethylpolysiloxane (containing 0.00213 mole/100 g of vinyl) having the following average compositional formula (a-4):

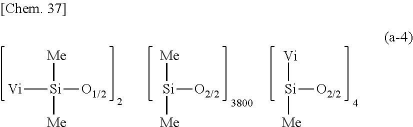

as component (A), 0.23 part by weight of methylhydrogenpolysiloxane having formula (c-1) as component (C), and 233.27 parts by weight of rubber solvent as component (H). The molar ratio of Si—H groups in component (C) to vinyl groups in component (A) was 1.7/1.

The primer cure, adhesion and elongation were evaluated as in Example 1 aside from using primer composition 24. The results are shown in Table 1.

### Comparative Example 5

A primer composition 25 for silicone PSA was prepared as in Comparative Example 1 aside from using 100 parts by weight of a dimethylpolysiloxane (containing 0.01772 mole/100 g of vinyl) having the following average compositional formula (a-5):

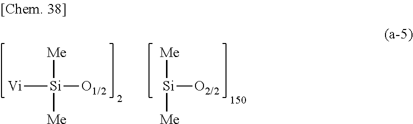

as component (A), 1.93 parts by weight of methylhydrogenpolysiloxane having formula (c-1) as component (C), and 237.24 parts by weight of rubber solvent as component (H). The molar ratio of Si—H groups in component (C) to vinyl groups in component (A) was 1.7/1.

The primer cure, adhesion and elongation were evaluated as in Example 1 aside from using primer composition 25. The results are shown in Table 1.

### Comparative Example 6

A primer composition 26 for silicone PSA was prepared by mixing 100 parts by weight of dimethylpolysiloxane having formula (b-1) as component (B), 23.54 parts by weight of methylhydrogenpolysiloxane having formula (c-1) as component (C), 0.60 part by weight of ethynylcyclohexanol as component (E), and 287.66 parts by weight of rubber solvent as component (H), to form a liquid mixture containing 30 wt % of solids, adding 0.5 part by weight of a toluene solution of 1,3-divinyl-1,1,3,3-tetramethyldisiloxane platinum(0) complex containing 0.5 wt % of platinum to the mixture, and diluting the mixture with a solvent of hexane and methyl ethyl ketone in a weight ratio of 1:1 so as to give a solid content of 5 wt %. The molar ratio of Si—H groups in component (C) to vinyl groups in component (B) was 1.7/1.

The primer cure, adhesion and elongation were evaluated as in Example 1 aside from using primer composition 26. The results are shown in Table 1.

### Comparative Example 7

A primer composition 27 for silicone PSA was prepared as in Comparative Example 6 aside from using 100 parts by weight of dimethylpolysiloxane having formula (b-2) as component (B), 45.66 parts by weight of methylhydrogenpolysiloxane having formula (c-1) as component (C), and 339.27 parts by weight of rubber solvent as component (H). The molar ratio of Si—H groups in component (C) to vinyl groups in component (B) was 1.7/1.

The primer cure, adhesion and elongation were evaluated as in Example 1 aside from using primer composition 27. The results are shown in Table 1.

TABLE 1

| | Primer composition for silicone PSA | | | | | | Adhesion after | Elongation (mm) after |
|---|---|---|---|---|---|---|---|---|
| | Component | Component | Component | Component | Component | Primer | 1 min heating/ | 1 min heating/ |
| | (A) | (B) | (C) | (F) | (G) | cure | 5 min heating | 5 min heating |
| Example 1 | (a-1) | (b-1) | (c-1) | | | ◯ | ◯/X | 1/25 |
| Example 2 | (a-1) | (b-1) | (c-1) | | | ◯ | ◯/X | 1/30 |
| Example 3 | (a-1) | (b-1) | (c-1) | | | ◯ | ◯/X | 2/25 |
| Example 4 | (a-1) | (b-2) | (c-1) | | | ◯ | ◯/X | 2/15 |
| Example 5 | (a-1) | (b-3) | (c-1) | | | ◯ | ◯/X | 2/30 |
| Example 6 | (a-2) | (b-1) | (c-1) | | | ◯ | ◯/X | 3/30 |
| Example 7 | (a-3) | (b-1) | (c-1) | | | ◯ | ◯/X | 2/30 |
| Example 8 | (a-1) | (b-1) | (c-1) | (f-1) | | ◯ | ◯/◯ | 1/1 |
| Example 9 | (a-1) | (b-1) | (c-1) | (f-2) | | ◯ | ◯/◯ | 1/2 |
| Example 10 | (a-1) | (b-1) | (c-1) | (f-3) | | ◯ | ◯/◯ | 2/1 |
| Example 11 | (a-1) | (b-1) | (c-1) | (f-4) | | ◯ | ◯/◯ | 3/3 |
| Example 12 | (a-1) | (b-1) | (c-1) | (f-5) | | ◯ | ◯/◯ | 1/3 |
| Example 13 | (a-1) | (b-1) | (c-1) | (f-1) | | ◯ | ◯/◯ | 1/1 |
| Example 14 | (a-1) | (b-1) | (c-1) | (f-1) | | ◯ | ◯/◯ | 1/2 |
| Example 15 | (a-1) | (b-2) | (c-1) | (f-1) | | ◯ | ◯/◯ | 2/5 |
| Example 16 | (a-1) | (b-3) | (c-1) | (f-1) | | ◯ | ◯/◯ | 1/3 |
| Example 17 | (a-2) | (b-1) | (c-1) | (f-1) | | ◯ | ◯/◯ | 1/1 |
| Example 18 | (a-3) | (b-1) | (c-1) | (f-1) | | ◯ | ◯/◯ | 2/2 |
| Example 19 | (a-1) | (b-1) | (c-1) | (f-1) | (g-1) | ◯ | ◯/◯ | 0/2 |
| Example 20 | (a-1) | (b-1) | (c-1) | (f-1) | (g-2) | ◯ | ◯/◯ | 1/1 |
| Comparative | (a-1) | | (c-1) | | | X | ◯/◯ | 2/3 |
| Example 1 | | | | | | | | |
| Comparative | (a-2) | | (c-1) | | | X | X/X | 20/25 |
| Example 2 | | | | | | | | |
| Comparative | (a-3) | | (c-1) | | | X | X/X | 30/30 |
| Example 3 | | | | | | | | |
| Comparative | (a-4) | | (c-1) | | | X | X/X | 20/20 |
| Example 4 | | | | | | | | |
| Comparative | (a-5) | | (c-1) | | | ◯ | X/X | 50/65 |
| Example 5 | | | | | | | | |
| Comparative | | (b-1) | (c-1) | | | X | X/X | 80/120 |
| Example 6 | | | | | | | | |
| Comparative | | (b-2) | (c-1) | | | X | X/X | 110/160 |
| Example 7 | | | | | | | | |

As is evident from the results in Table 1, Examples 1 to 7 showed satisfactory cure and adhesion in a compatible way. It is presumed that since the relatively long-chain siloxane as component (A) affords flexibility for effective bond to the silicone PSA layer, and the highly reactive low-molecular-weight siloxane as component (B) supplements the rate of crosslink formation of component (A), the adhesion to the silicone PSA (i.e., cured silicone PSA composition) and cure are met in a compatible way.

It is noted that when the curing time of the primer composition is extended, the adhesion is exacerbated, but improved by using a silane coupling agent as component (F) in combination, as seen from Examples 8 to 20. It is empirically known that when a primer composition is over-cured, the adhesion between the cured composition (primer layer) and the silicone PSA is exacerbated. This is probably because the primer layer is weakened in anchoring force. It is believed as one hypothesis that the primer composition in under-cured or semi-cured state is wettable to the silicone PSA composition and develops a stronger anchoring force. It is believed that since a silane coupling agent plays the role of a wetter when added to a primer composition, the primer composition maintains the adhesion to the silicone PSA even after the primer composition is fully cured.

Comparative Example 1 fails to meet both adhesion and cure in that the adhesion to the silicone PSA is good, but the primer composition is less curable. It is surmised that since component (B) is omitted, the primer composition is based on a siloxane of greater chain length which is low reactive. Comparative Examples 2 to 4, which do not contain component (B), exhibit poor adhesion to the silicone PSA. In Comparative Examples 2 and 3, because the crosslinking density is increased over Comparative Example 1, a cured coating of the primer composition becomes slightly harder so as to restrain the primer from developing an anchoring force. In Comparative Example 4 wherein the base of the primer composition has a too long molecule (has a higher degree of polymerization than component (A) according to the invention), the progress of cure is retarded so that the primer composition itself does not fully act on the substrate. In Comparative Example 5 using a siloxane outside components (A) and (B) as the base polymer, the primer composition is fully curable, but the adhesion to silicone PSA is insufficient because the crosslinking density is increased as in Comparative Examples 2 and 3, and a cured product of the primer composition becomes a hard coating. In Comparative Examples 6 and 7 which do not contain component (A), it is believed that many reactive sites are available so that the primer composition is less curable.

1. A primer composition for silicone pressure-sensitive adhesives, comprising:
(A) 100 parts by weight of an organopolysiloxane containing at least two alkenyl-containing organic groups in the molecule and having an alkenyl content of 0.001 to 0.008 mole per 100 g of the organopolysiloxane, represented by the average compositional formula (1): 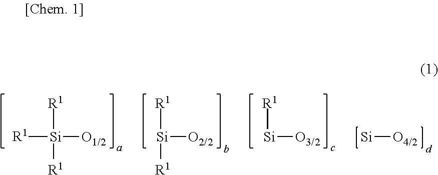
wherein R¹ which may be the same or different is a hydroxyl group, C₁-C₃ alkoxy group, substituted or unsubstituted C₁-C₁₀ monovalent hydrocarbon group free of aliphatic unsaturation, or C₂-C₁₀ alkenyl-containing organic group, at least two of R¹ being C₂-C₁₀ alkenyl-containing organic groups, a is an integer of at least 2, b is an integer of at least 1, c and d each are an integer of at least 0, and 400≤a+b+c+d≤2,000,
(B) 1 to 20 parts by weight of an organopolysiloxane containing at least two alkenyl-containing organic groups in the molecule and having an alkenyl content of 0.15 to 1.3 moles per 100 g of the organopolysiloxane, represented by the average compositional formula (2): 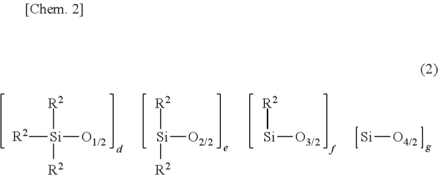
wherein R² which may be the same or different is a hydroxyl group, C₁-C₃ alkoxy group, substituted or unsubstituted C₁-C₁₀ monovalent hydrocarbon group free of aliphatic unsaturation, or C₂-C₁₀ alkenyl-containing organic group, at least two of R² being C₂-C₁₀ alkenyl-containing organic groups, e to h each are an integer of at least 0, and 2≤e+f+g+h≤20,
(C) an organohydrogenpolysiloxane containing at least three Si—H groups in the molecule, but not alkoxy and epoxy groups, in such an amount that a molar ratio of Si—H groups to the total of alkenyl groups in components (A) and (B) ranges from 0.5/1 to 30/1, and
(D) a platinum group metal based catalyst for promoting hydrosilylation addition reaction between alkenyl groups in components (A) and (B) and Si—H groups in component (C) for curing, in such an amount as to give 1 to 500 ppm of metal based on the weight of component (A).

2. The primer composition of claim 1, further comprising (E) 0.01 to 5 parts by weight of a reaction regulator per 100 parts by weight of components (A) to (C) combined.

3. The primer composition of claim 1 or 2, further comprising (F) 0.5 to 10 parts by weight of a silane coupling agent per 100 parts by weight of component (A).

4. The primer composition of claim 3 wherein component (F) is a silane coupling agent having the general formula (3):
R³ᵢSi(OR⁴)₄₋ᵢ (3)
wherein R³ is a monovalent organic group free of nitrogen, sulfur, phosphor and tin elements, R⁴ is C₁-C₄ alkyl, and i is a number 1≤i≤3.

5. The primer composition of claim 1, further comprising (G) 0.1 to 10 parts by weight of a compound having the general formula (4) or (5) per 100 parts by weight of component (A), 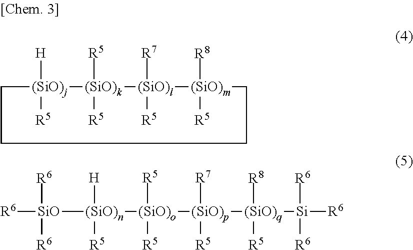
wherein R⁵ which may be the same or different is a substituted or unsubstituted C₁-C₁₀ monovalent hydrocarbon group free of aliphatic unsaturation, R⁶ is hydrogen or R⁵, R⁷ is an epoxy-containing organic group, R⁸ is an alkoxysilyl-containing organic group, j and n each are an integer of at least l, k and o each are an integer of at least 0, l, m, p and q each are an integer of at least 0, l+m and p+q each are an integer of at least 1.

6. The primer composition of claim 1, further comprising (H) 5 to 2,000 parts by weight of an organic solvent per 100 parts by weight of component (A).

7. An article comprising a substrate and a cured coating of the primer composition of claim 1 thereon.

8. A pressure-sensitive adhesive article comprising the article of claim 7 and a cured product of a silicone pressure-sensitive adhesive composition on the surface of the cured coating of the primer composition.

9. The pressure-sensitive adhesive article of claim 8 wherein the silicone pressure-sensitive adhesive composition is curable through hydrosilylation.
